(19) United States
(12) Patent Application Publication
(10) Pub. No.: US 2026/0195391 A1
(43) Pub. Date: Jul. 9, 2026

(54) PARAMETER ADJUSTING DEVICE AND PARAMETER ADJUSTING METHOD

(71) Applicant: Mitsubishi Electric Corporation, Tokyo (JP)

(72) Inventor: Rin ITO, Tokyo (JP)

(73) Assignee: Mitsubishi Electric Corporation, Tokyo (JP)

(21) Appl. No.: 19/555,444

(22) Filed: Mar. 3, 2026

Related U.S. Application Data
(63) Continuation of application No. PCT/JP2023/038413, filed on Oct. 25, 2023.

(51) Int. Cl. G06F 16/953

(52) U.S. Cl. CPC G06F 16/953

(57) ABSTRACT

A parameter adjusting device includes: a data acquiring unit to acquire data including a value of each of parameters and an evaluation value relating to the value of each of the parameters from an evaluation value calculating device that acquires an operation result of a device to be adjusted that performs operation using one parameter or parameters and calculates an evaluation value for the operation result; and an elite solution extracting unit to extract zero or more pieces of data as an elite solution from among acquired data. In addition, the parameter adjusting device includes a parameter value determining unit to determine a value of a parameter to be used for the next operation by the device to be adjusted from among values of parameters present in a search space for values of parameters, and output the determined value of the parameter to the device to be adjusted.

### CROSS REFERENCE TO RELATED APPLICATION

This application is a Continuation of PCT International Application No. PCT/JP2023/038413, filed on Oct. 25, 2023, which is hereby expressly incorporated by reference into the present application.

### TECHNICAL FIELD

The present disclosure relates to a parameter adjusting device and a parameter adjusting method.

### BACKGROUND ART

There is a parameter adjusting method for searching for a plurality of parameters used for operation of a device to be adjusted.

As such a parameter adjusting method, for example, Non Patent Literature 1 discloses a method in which a plurality of optimizers searches for parameters.

The method disclosed in Non Patent Literature 1 has a reception function of receiving specification of the number of optimizers. Each optimizer is software or the like for setting one parameter or a plurality of parameters that can be used for the operation of the device to be adjusted.

### CITATION LIST

### Non Patent Literatures

Non Patent Literature 1: “Discovering Many Diverse Solutions with Bayesian Optimization”, the 10953rd article posted on arXiv, October 2022

### SUMMARY OF INVENTION

### Technical Problem

In the method disclosed in Non Patent Literature 1, there is a problem that, in a case where a parameter value (hereinafter referred to as a “parameter value”) is set, if the proper number of parameter values is unknown, it is difficult for a user to specify a proper number as the number of optimizers to be executed. The proper number is a number by which it is possible to find many parameter values that can be variously and highly evaluated within an allowable range of degradation of search efficiency, which is the efficiency of searching for a proper parameter value. If the specified number of optimizers is too small than the proper number, the diversity of parameter values is lost. If the number of optimizers specified is too large than the proper number, the search efficiency for parameters is deteriorated.

The present disclosure has been made to solve the above problems, and an object of the present disclosure is to obtain a parameter adjusting device capable of searching for diverse parameter values within an allowable range of degradation of search efficiency even when the proper number of parameter values to be found is unknown.

### Solution to Problem

A parameter adjusting device according to the present disclosure includes: a data acquiring circuit to acquire data including a value of each of parameters and an evaluation value relating to the value of each of the parameters from an evaluation value calculating device that acquires an operation result of a device to be adjusted that performs operation using one parameter or a plurality of parameters and calculates an evaluation value for the operation result; and an elite solution extracting circuit to extract zero or more pieces of data as an elite solution from among a plurality of pieces of data acquired by the data acquiring circuit on the basis of an evaluation value included in each of the pieces of data. In addition, the parameter adjusting device includes a parameter value determining circuit to determine a value of a parameter to be used for the next operation by the device to be adjusted on the basis of the elite solution extracted by the elite solution extracting circuit from among a plurality of values of parameters present in a search space for values of parameters, and output the determined value of the parameter to the device to be adjusted, wherein the parameter value determining circuit includes: a determination method selecting circuit to select one of a global search method and a local search method as a method of determining a value of a parameter to be used for next operation on a basis of an elite solution extracted by the elite solution extracting circuit; a sampling circuit to sample a value or values of one or more parameters in accordance with a probability distribution uniformly spreading over the entire search space when the global search method is selected by the determination method selecting circuit, and sample a value or values of one or more parameters in accordance with a probability distribution centered on a certain elite solution in the search space when the local search method is selected by the determination method selecting circuit; and a parameter value determination processing circuit to calculate a distance between each of values of the parameters sampled by the sampling circuit and a value of a parameter included in the elite solution extracted by the elite solution extracting circuit, and on a basis of the distance, determine a value of a parameter to be used for next operation by the device to be adjusted from among values of one or more parameters sampled by the sampling circuit.

### Advantageous Effects of Invention

According to the present disclosure, even when an appropriate number of parameter values to be found is unknown, it is possible to search for diverse parameter values within an allowable range of degradation in search efficiency.

### BRIEF DESCRIPTION OF DRAWINGS

FIG. 1 is a configuration diagram illustrating a system including a parameter adjusting device 3 according to a first embodiment.

FIG. 2 is a hardware configuration diagram illustrating hardware of the parameter adjusting device 3 according to the first embodiment.

FIG. 3 is a hardware configuration diagram of a computer in a case where the parameter adjusting device 3 is implemented by software, firmware, or the like.

FIG. 4 is a flowchart illustrating a parameter adjusting method that is a processing procedure performed by the parameter adjusting device 3.

FIG. 5 is a flowchart illustrating extraction processing of an elite solution E^{j} (j=1, . . . , J) performed by an elite solution extracting unit 12.

FIG. 6 is a flowchart illustrating selection processing of a determination method performed by a determination method selecting unit 14a.

FIG. 7 is a flowchart illustrating determination processing and the like of a parameter value performed by a parameter value determination processing unit 14c.

FIG. 8 is a configuration diagram illustrating a system including a parameter adjusting device 3 according to a second embodiment.

FIG. 9 is a hardware configuration diagram illustrating hardware of the parameter adjusting device 3 according to the second embodiment.

FIG. 10 is a configuration diagram illustrating a system including a parameter adjusting device 3 according to a third embodiment.

FIG. 11 is a hardware configuration diagram illustrating hardware of the parameter adjusting device 3 according to the third embodiment.

FIG. 12 is a configuration diagram illustrating a system including a parameter adjusting device 3 for an air conditioner according to a fifth embodiment.

### DESCRIPTION OF EMBODIMENTS

Hereinafter, in order to describe the present disclosure in more detail, modes for carrying out the present disclosure will be described with reference to the accompanying drawings.

### First Embodiment

Development efficiency and the like may be improved by finding a combination of values of a plurality of parameters (hereinafter referred to as “parameter values”) having diversity at a time.

For example, in order to find a simulation scenario in which a vehicle control system under development falls into an unsafe state, a case is considered in which the parameter value of the scenario parameter is automatically adjusted with a risk level as an evaluation value. At this time, development can be made efficient by automatically extracting as many diverse and dangerous scenarios as possible.

In addition, there may be an evaluation item, a constraint condition, or the like that can be evaluated only after parameter adjustment. For example, there is a case where a parameter value of a control parameter is adjusted in advance using a simulator for a machine device, and then an actual device is controlled using the extracted control parameter value, thereby checking whether or not a failure that cannot be reproduced by simulation occurs. If there is only one extracted parameter value, it is necessary to start over from the automatic adjustment using the simulator when a failure occurs in an actual device, but if a plurality of combinations of various parameter values is extracted, the possibility that any combination of parameter values passes a test by the actual device increases, resulting in improvement of the development efficiency.

A parameter adjusting device 3 capable of searching for combinations of a plurality of parameter values having diversity within an allowable range of degradation in search efficiency even when the proper number of parameter values to be found is unknown will be described.

Hereinafter, in order to describe the present disclosure in more detail, modes for carrying out the present disclosure will be described with reference to the accompanying drawings.

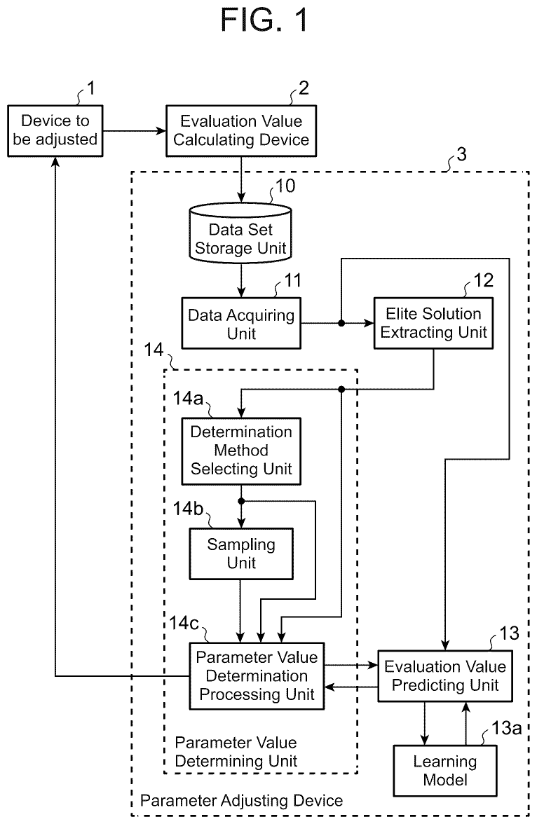

FIG. 1 is a configuration diagram illustrating a system including the parameter adjusting device 3 according to a first embodiment.

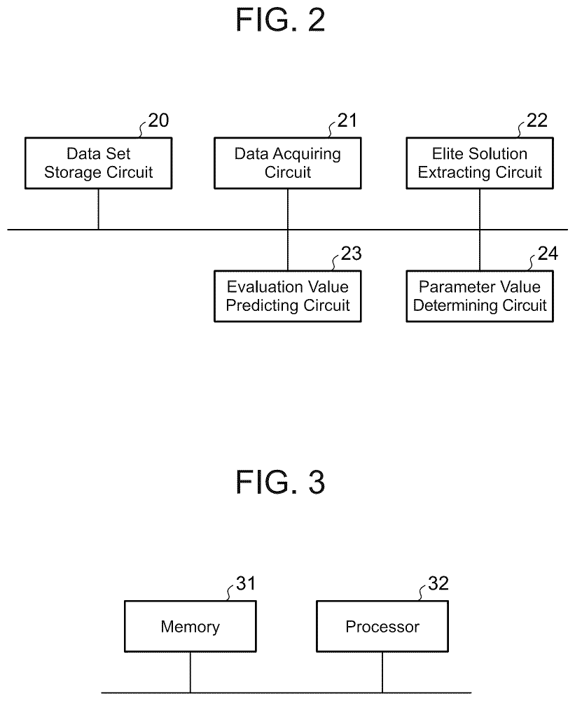

FIG. 2 is a hardware configuration diagram illustrating hardware of the parameter adjusting device 3 according to the first embodiment.

The system illustrated in FIG. 1 includes a device 1 to be adjusted, an evaluation value calculating device 2, and the parameter adjusting device 3.

The device 1 to be adjusted performs operation using one parameter or a plurality of parameters, and outputs an operation result to the evaluation value calculating device 2.

Examples of the device 1 to be adjusted include a simulator for an automated driving system and a simulator for an air conditioner. When the device 1 to be adjusted is, for example, a simulator for an air conditioner, the parameters used for the operation of the device 1 to be adjusted include, for example, an operation pattern of a frequency in a compressor or an operation pattern of an expansion valve.

The evaluation value calculating device 2 is an evaluation value calculating device that acquires an operation result of the device 1 to be adjusted related to each parameter value from the device 1 to be adjusted that has operated using the parameter value of each parameter, and calculates an evaluation value for the operation result.

When the parameter used for the operation of the device 1 to be adjusted is, for example, the operation pattern of the frequency in the compressor, for example, it is evaluated, as the evaluation value for the operation result, as to how long it takes for the temperature of a space to be air-conditioned by the air conditioner reaches a set temperature on the basis of the environmental condition of the air conditioner set in advance, for example. The shorter the time until the temperature of the space to be air-conditioned reaches the set temperature, the higher the evaluation value for the operation result.

The evaluation value calculating device 2 outputs data including each parameter value and an evaluation value related to each parameter value to the parameter adjusting device 3.

In the system illustrated in FIG. 1, the evaluation value calculating device 2 is provided outside the parameter adjusting device 3. However, this is merely an example, and the evaluation value calculating device 2 may be provided inside the parameter adjusting device 3.

The parameter adjusting device 3 includes a data set storage unit 10, a data acquiring unit 11, an elite solution extracting unit 12, an evaluation value predicting unit 13, a learning model 13a, and a parameter value determining unit 14.

The parameter adjusting device 3 is a device that searches for a plurality of parameter values used for operating the device 1 to be adjusted.

The data set storage unit 10 is implemented by, for example, a data set storage circuit 20 illustrated in FIG. 2.

The data set storage unit 10 acquires data including each parameter value and an evaluation value related to each parameter value from the evaluation value calculating device 2, and stores a combination of all data acquired in the past as a data set. The data set includes one or more data.

The data acquiring unit 11 is implemented by, for example, a data acquiring circuit 21 illustrated in FIG. 2.

The data acquiring unit 11 acquires a data set from the data set storage unit 10.

The data acquiring unit 11 outputs the data set to each of the elite solution extracting unit 12 and the evaluation value predicting unit 13.

The elite solution extracting unit 12 is implemented by, for example, an elite solution extracting circuit 22 illustrated in FIG. 2.

The elite solution extracting unit 12 acquires a data set from the data acquiring unit 11.

The elite solution extracting unit 12 extracts zero or one or more pieces of data from the data set as an elite solution on the basis of an evaluation value included in each piece of data.

Specifically, the elite solution extracting unit 12 extracts, as the elite solution, data whose evaluation value included is equal to or greater than a lower limit value among the data included in the data set.

The elite solution extracting unit 12 outputs zero or more elite solutions to the parameter value determining unit 14.

The evaluation value predicting unit 13 is implemented by, for example, an evaluation value predicting circuit 23 illustrated in FIG. 2.

The evaluation value predicting unit 13 predicts an evaluation value for the operation result of the device 1 to be adjusted when the device 1 to be adjusted operates using each parameter value sampled by a sampling unit 14b described later of the parameter value determining unit 14.

Specifically, upon receiving a parameter value from a parameter value determination processing unit 14c to be described later of the parameter value determining unit 14, the evaluation value predicting unit 13 gives the parameter value to the learning model 13a, and acquires an evaluation value corresponding to at least the parameter value from the learning model 13a as a prediction result of the evaluation value for the operation result.

The evaluation value predicting unit 13 outputs the prediction result of the evaluation value to the parameter value determination processing unit 14c.

The learning model 13a is implemented by, for example, a Gaussian process regression model, a linear regression model, a neural network, a decision tree, a random forest, or a gradient boosting tree.

When the parameter value included in each data acquired by the data acquiring unit 11 and the evaluation value included in each piece of data are given at the time of learning, the learning model 13a learns the evaluation value corresponding to each parameter value. The evaluation value is teacher data.

When a parameter value is given from the evaluation value predicting unit 13 at the time of inference, the learning model 13a outputs an evaluation value corresponding to the parameter value to the evaluation value predicting unit 13 as a prediction result of the evaluation value.

The parameter adjusting device 3 illustrated in FIG. 1 includes a learning model 13a. However, this is merely an example, and the learning model 13a may be provided outside the parameter adjusting device 3.

The parameter value determining unit 14 is implemented by, for example, a parameter value determining circuit 24 illustrated in FIG. 2.

The parameter value determining unit 14 includes a determination method selecting unit 14a, a sampling unit 14b, and a parameter value determination processing unit 14c.

The parameter value determining unit 14 determines a parameter value to be used for the next operation by the device 1 to be adjusted on the basis of the elite solution extracted by the elite solution extracting unit 12 from among a plurality of parameter values present in the search space of parameter values.

The parameter value determining unit 14 outputs the determined parameter value to the device 1 to be adjusted.

The determination method selecting unit 14a acquires zero or more elite solutions from the elite solution extracting unit 12.

On the basis of the number of elite solutions extracted by the elite solution extracting unit 12, the determination method selecting unit 14a selects either a global search method or a local search method as the method of determining the parameter value to be used for the next driving. The global search method is a search method of sampling a parameter value according to a probability distribution uniformly spreading over the entire search space of parameter values. The local search method is a search method of sampling a parameter value from the search space of parameter values according to a probability distribution centered on a certain elite solution.

Specifically, the determination method selecting unit 14a selects the global search method when the number of elite solutions extracted by the elite solution extracting unit 12 is zero.

If the number of elite solutions extracted by the elite solution extracting unit 12 is equal to or more than one, the determination method selecting unit 14a selects either the global search method or the local search method on the basis of the probability that the local search method is selected.

The probability that the local search method is selected is calculated by the determination method selecting unit 14a on the basis of the evaluation value included in the elite solution extracted by the elite solution extracting unit 12.

When the global search method is selected by the determination method selecting unit 14a, the sampling unit 14b samples one or more parameter values according to the probability distribution uniformly spreading over the entire search space of parameter values.

When the local search method is selected by the determination method selecting unit 14a, the sampling unit 14b samples one or more parameter values according to the probability distribution centered on a certain elite solution in the search space of parameter values.

The sampling unit 14b outputs the sampled parameter value to the parameter value determination processing unit 14c.

The parameter value determination processing unit 14c acquires zero or one or more elite solutions from the elite solution extracting unit 12, and acquires one or more parameter values from the sampling unit 14b.

In addition, the parameter value determination processing unit 14c acquires a prediction result of the evaluation value from the evaluation value predicting unit 13.

The parameter value determination processing unit 14c calculates a distance between each acquired parameter value and a parameter value included in each acquired elite solution.

The parameter value determination processing unit 14c determines one parameter value to be used for the next operation of the device 1 to be adjusted from among one or more parameter values sampled by the sampling unit 14b on the basis of the calculated distance and the prediction result of the evaluation value.

In FIG. 1, it is assumed that each of the data set storage unit 10, the data acquiring unit 11, the elite solution extracting unit 12, the evaluation value predicting unit 13, and the parameter value determining unit 14, which are components of the parameter adjusting device 3, is implemented by dedicated hardware as illustrated in FIG. 2. That is, it is assumed that the parameter adjusting device 3 is implemented by the data set storage circuit 20, the data acquiring circuit 21, the elite solution extracting circuit 22, the evaluation value predicting circuit 23, and the parameter value determining circuit 24.

Here, the data set storage circuit 20 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

Each of the data acquiring circuit 21, the elite solution extracting circuit 22, the evaluation value predicting circuit 23, and the parameter value determining circuit 24 corresponds to, for example, a single circuit, a composite circuit, a programmed processor, a parallel programmed processor, an application specific integrated circuit (ASIC), a field-programmable gate array (FPGA), or a combination thereof.

The components of the parameter adjusting device 3 are not limited to those implemented by dedicated hardware, and the parameter adjusting device 3 may be implemented by software, firmware, or a combination of software and firmware.

The software or firmware is stored in a memory of a computer as a program. The computer means hardware that executes a program, and corresponds to, for example, a central processing unit (CPU), a graphics processing unit (GPU), a central processing unit, a processing unit, an arithmetic unit, a microprocessor, a microcomputer, a processor, or a digital signal processor (DSP).

FIG. 3 is a hardware configuration diagram of a computer in a case where the parameter adjusting device 3 is implemented by software, firmware, or the like.

In a case where the parameter adjusting device 3 is implemented by software, firmware, or the like, the data set storage unit 10 is configured on a memory 31 of the computer. A program for causing a computer to execute each processing procedure performed in the data acquiring unit 11, the elite solution extracting unit 12, the evaluation value predicting unit 13, and the parameter value determining unit 14 is stored in the memory 31. Then, a processor 32 of the computer executes the program stored in the memory 31.

Further, FIG. 2 illustrates an example in which each of the components of the parameter adjusting device 3 is implemented by dedicated hardware, and FIG. 3 illustrates an example in which the parameter adjusting device 3 is implemented by software, firmware, or the like. However, this is merely an example, and some components in the parameter adjusting device 3 may be implemented by dedicated hardware, and the remaining components may be implemented by software, firmware, or the like.

Next, operation of the system illustrated in FIG. 1 will be described.

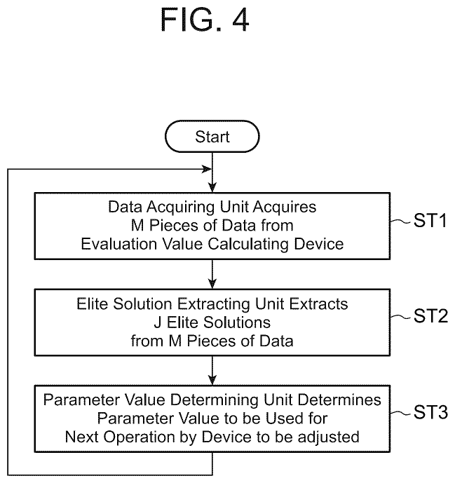

FIG. 4 is a flowchart illustrating a parameter adjusting method which is a processing procedure performed by the parameter adjusting device 3.

There are I adjustable parameters pᵢ in the device 1 to be adjusted. i=1, . . . , I, and I is an integer equal to or more than one. A parameter value of the parameter pᵢ is xᵢ, and a vector including all the parameter values xᵢ is X as illustrated in the following Formula (1).

$$X = ( {x}_{1} , {x}_{2} , … , {x}_{I} ) \qquad ( 1 )$$

First, the parameter value determining unit 14 sets initial values x_{i,init} of all parameters pᵢ (i=1, . . . , I) to the device 1 to be adjusted.

The initial value x_{i,init} of the parameter pᵢ may be determined by using a pseudorandom number, for example. In addition, the initial value x_{i,init} of the parameter pᵢ may be such a parameter value as long as the parameter value xᵢ of the parameter pᵢ with which the evaluation value y for the operation result of the device 1 to be adjusted increases is known.

The device 1 to be adjusted operates using a parameter value X.

The device 1 to be adjusted outputs the parameter value X and an operation result corresponding to the parameter value X to the evaluation value calculating device 2.

When the device 1 to be adjusted is, for example, a simulator for an automated driving system, the operation result of the device 1 to be adjusted includes, for example, positions (or relative positions) of a host vehicle and another vehicle or the like or speeds (or relative speeds) of the host vehicle and another vehicle or the like at a plurality of time points included in a simulation period.

When the device 1 to be adjusted is, for example, a simulator for an air conditioner, the operation result of the device 1 to be adjusted includes, for example, a state quantity of air conditioning. Examples of the state quantity of air conditioning include the temperature of the refrigerant, the pressure of the refrigerant, the heating capacity, the cooling capacity, and the energy saving efficiency.

The evaluation value calculating device 2 acquires the parameter value X and the operation result corresponding to the parameter value X from the device 1 to be adjusted.

The evaluation value calculating device 2 calculates an evaluation value y for the operation result. Since the calculation processing itself of the evaluation value y by the evaluation value calculating device 2 is a known technique, detailed description thereof will be omitted.

In a case where the device 1 to be adjusted is a simulator for an automated driving system, for example, when the host vehicle approaches another vehicle or the like, the shorter the distance between the host vehicle and the another vehicle or the like, the lower the evaluation value y for the operation result.

In a case where the device 1 to be adjusted is a simulator for an air conditioner, for example, it is evaluated as to how long it takes for the temperature of the space to be air-conditioned by the air conditioner to reach the set temperature on the basis of a preset environmental condition of the air conditioner. The shorter the time until the temperature of the space to be air-conditioned reaches the set temperature, the higher the evaluation value for the operation result. Alternatively, the evaluation value may be calculated in such a manner that the evaluation value y for the operation result increases as the heating capacity or the cooling capacity increases.

The evaluation value calculating device 2 outputs data D including the parameter value X and the evaluation value y to the parameter adjusting device 3 as expressed in the following Formula (2).

$$D = ( X , y ) \qquad ( 2 )$$

The data acquiring unit 11 of the parameter adjusting device 3 acquires M pieces of stored data D¹ to D^{M} from the evaluation value calculating device 2 (step ST1 in FIG. 4).

The data acquiring unit 11 outputs the M pieces of data D¹ to D^{M} to each of the elite solution extracting unit 12 and the evaluation value predicting unit 13.

The elite solution extracting unit 12 acquires the M pieces of data D¹ to D^{M} from the data acquiring unit 11.

The elite solution extracting unit 12 extracts J pieces of data as elite solutions E¹ to E^{J} from the M pieces of data D¹ to D^{M} on the basis of the evaluation value y^{m} included in the data D^{m} (m=1, . . . , M) (step ST2 in FIG. 4). j=1, . . . , J, and j does not indicate a power of E but indicates an index. J is an integer equal to or more than 0 and equal to or less than M.

The elite solution extracting unit 12 outputs the J elite solutions E¹ to E^{J} to the parameter value determining unit 14.

Hereinafter, the process of extracting the elite solution E^{j} (j=1, . . . , J) by the elite solution extracting unit 12 will be specifically described.

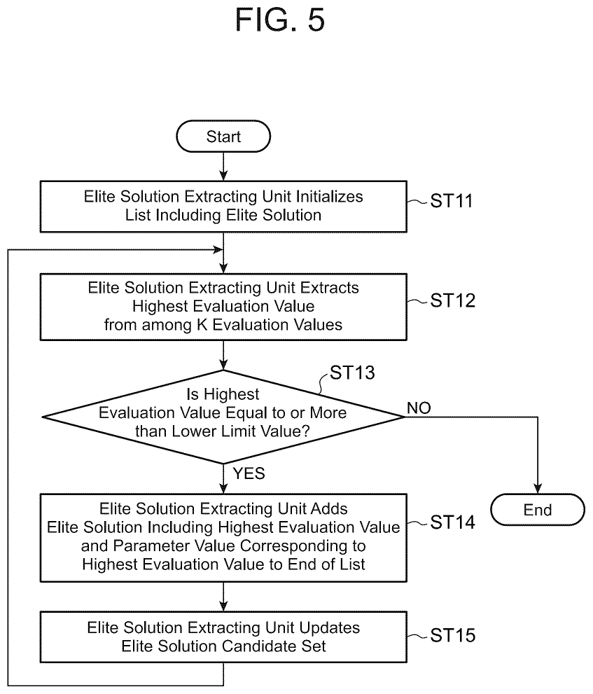

FIG. 5 is a flowchart illustrating extraction processing of the elite solution E^{j} (j=1, . . . , J) performed by the elite solution extracting unit 12.

First, the elite solution extracting unit 12 sets the M pieces of data D¹ to D^{M} as K elite solution candidates Ec¹ to Ec^{K}. K is an integer equal to or more than zero, and at this stage, K is equal to M. A set of the elite solution candidates is set as an elite solution candidate set Ec={Ec¹, . . . , Ec^{K}}.

Next, the elite solution extracting unit 12 initializes a list E including the elite solution E^{j} as expressed in the following Formula (3) (step ST11 in FIG. 5).

$$E = [ ] \qquad ( 3 )$$

In Formula (3), [□] indicates an empty list.

The elite solution extracting unit 12 compares evaluation values y¹ to y^{K} included in the K elite solution candidates Ec¹ to Ec^{K} with each other.

The elite solution extracting unit 12 extracts the highest evaluation value yₘₐₓ from among the K evaluation values y¹ to y^{K} on the basis of the comparison result (step ST12 in FIG. 5).

The elite solution extracting unit 12 compares the highest evaluation value yₘₐₓ with the lower limit value y_{L} of the evaluation value. The lower limit value y_{L} may be stored, for example, in the internal memory of the elite solution extracting unit 12 or may be given from the outside of the parameter adjusting device 3.

When the evaluation value yₘₐₓ is less than the lower limit value y_{L} (step ST13 in FIG. 5: NO), the elite solution extracting unit 12 ends the process of extracting the elite solution E^{j}.

When the evaluation value yₘₐₓ is equal to or more than the lower limit value y_{L} (step ST13 in FIG. 5: YES), the elite solution extracting unit 12 adds the elite solution candidate Ec^{k} including the evaluation value yₘₐₓ and the parameter value X corresponding to the evaluation value yₘₐₓ to the end of the list E as the elite solution E^{j} (step ST14 in FIG. 5).

Hereinafter, in order to distinguish the parameter value X included in the elite solution E^{j} from the parameter value X included in the elite solution candidate Ec^{k}(k=1, . . . , K), the parameter included in the elite solution E^{j} is expressed as X_{E}^{j}. In addition, in order to distinguish the evaluation value included in the elite solution E^{j} from the evaluation value y included in the elite solution candidate Ec^{k}, the evaluation value included in the elite solution E^{j} is expressed as y_{E}^{j}.

Furthermore, here, the elite solution E^{j} includes the parameter value X^{j} and the evaluation value y^{j}. However, this is merely an example, and the elite solution E^{j} may include only the parameter value X^{j}.

The elite solution extracting unit 12 updates the elite solution candidate set Ec with a new elite solution candidate set Ec′ (step ST15 in FIG. 5).

The elite solution extracting unit 12 calculates a distance d (X^{k}, X_{E}^{j}) between a parameter value X^{k} included in Ec^{k} and a parameter value X_{E} included in all the elite solutions E^{j} included in the list E for a certain elite solution candidate Ec^{k} among the M elite solution candidates Ec¹ to Ec^{K}.

As illustrated in the following Formula (4), when the minimum distance min d (X^{k}, X_{E}^{j}) is equal to or more than the threshold T among all the calculated distances d (X^{k}, X_{E}^{j}), the elite solution extracting unit 12 includes the elite solution candidate Ec^{k} in the new elite solution candidate set Ec′. When the minimum distance min d (X^{k}, X_{E}^{j}) is less than the threshold τ, the elite solution extracting unit 12 removes the elite solution candidate Ec^{k} from the new elite solution candidate set Ec′.

The elite solution extracting unit 12 generates a new elite solution candidate set Ec′ by similarly processing each of the elite solution candidates Ec^{k}, and then sets this Ec′ as the elite solution candidate set Ec. The threshold τ may be stored, for example, in the internal memory of the elite solution extracting unit 12 or may be given from the outside of the parameter adjusting device 3.

The elite solution extracting unit 12 continues to perform processing of steps ST12 to ST15 in FIG. 5.

$${E}_{C}^{′} = \{ ( {X}^{k} , {y}^{k} ) ∈ {E}_{c} \vert {min}_{{X}_{E}^{j} ∈ E} d ( {X}^{k} , {X}_{E}^{j} ) \geq τ \} \qquad ( 4 )$$

In Formula (4), d (X^{k}, X_{E}^{j}) is a function that calculates a distance between the parameter value X^{k} and the parameter value X_{E}^{j}.

Examples of the function d (X^{k}, X_{E}^{j}) include a function using a distance of a parameter space. Specifically, for example, a Euclidean distance in a space spanned by any one of the parameter vector X, a vector obtained by normalizing the parameter vector X, and a vector obtained by subjecting the parameter vector X to nonlinear conversion or the like using a kernel method, or a Manhattan distance in a space spanned by any one of the vectors can be used as the distance between the parameters. Alternatively, the distance may be similarly defined using one value or a plurality of values from among the parameter value, the operation result, and the evaluation value.

Here, if the evaluation value yₘₐₓ is less than the lower limit value y_{L}, the elite solution extracting unit 12 ends the process of extracting the elite solution E^{j}. The elite solution extracting unit 12 may also end the process of extracting the elite solution E^{j} when the number of the elite solutions E^{j} included in the list E exceeds a predetermined number. In this case, it is possible to suppress a decrease in search efficiency due to an excessive increase in the elite solution E^{j}.

Here, the lower limit value y_{L} of the evaluation value is stored, for example, in the internal memory of the elite solution extracting unit 12. The elite solution extracting unit 12 may calculate the lower limit value y_{L} on the basis of the highest evaluation value yₘₐₓ among the M evaluation values y₁ to y_{M} stored in the data set storage unit 10 as expressed in the following Formula (5).

$${y}_{L} = α \times {y}_{max} + β \qquad ( 5 )$$

In Formula (5), each of α and β is a constant.

The parameter value determining unit 14 acquires J elite solutions E¹ to E^{J} from the elite solution extracting unit 12.

The parameter value determining unit 14 determines the parameter value to be used for the next operation by the device 1 to be adjusted on the basis of the J elite solutions E¹ to E^{J} from among the plurality of parameter values present in the search space of parameter values (step ST3 in FIG. 4).

The parameter value determining unit 14 outputs the determined parameter value to the device 1 to be adjusted.

Hereinafter, parameter determination processing by the parameter value determining unit 14 will be specifically described.

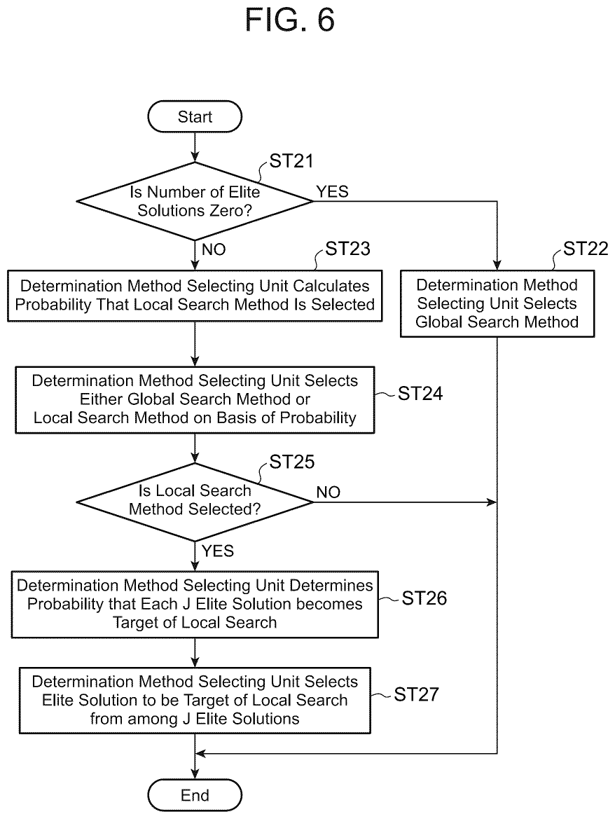

FIG. 6 is a flowchart illustrating selection processing of the determination method by the determination method selecting unit 14a.

The determination method selecting unit 14a acquires J elite solutions E¹ to E^{J} from the elite solution extracting unit 12.

On the basis of the number of elite solutions E¹ to E^{J}, the determination method selecting unit 14a selects either the global search method or the local search method as the method of determining the parameter value to be used for the next operation.

Specifically, if the number of elite solutions E^{j} extracted by the elite solution extracting unit 12 is zero (step ST21 in FIG. 6: YES), the determination method selecting unit 14a selects the global search method (step ST22 in FIG. 6).

If the number of the elite solutions E^{j} extracted by the elite solution extracting unit 12 is equal to or more than one (step ST21 in FIG. 6: NO), the determination method selecting unit 14a calculates a probability p that the local search method is selected (step ST23 in FIG. 6).

A method of calculating the probability p by which the local search method is selected may be any method, and as a method of calculating the probability p, for example, there is a method of using a predetermined probability.

Further, the determination method selecting unit 14a may use a method of calculating the probability p that the local search is selected in accordance with the number of elite solutions E^{j}. Specifically, the determination method selecting unit 14a calculates the probability p in such a manner that the probability p that the local search is selected increases as the number of elite solutions E^{j} increases. In this case, an effect of easily finding a parameter with higher evaluation can be obtained.

Further, the determination method selecting unit 14a may use a method of calculating the probability p of selecting the local search method on the basis of the evaluation value y^{j} included in the elite solution E^{j}. Specifically, the determination method selecting unit 14a calculates the probability p in such a manner that the probability p of selecting the local search method increases as the total value of the J evaluation values y¹ to y^{J} or the average value of the J evaluation values y¹ to y^{J} increases.

The determination method selecting unit 14a selects either the global search method or the local search method on the basis of the probability p (step ST24 in FIG. 6).

When the global search method is selected (step ST25 in FIG. 6: NO), the determination method selecting unit 14a ends the determination method selection processing.

When the local search method is selected (step ST25 in FIG. 6: YES), the determination method selecting unit 14a determines the probability pₑ^{j} that each of the J elite solutions E¹ to E^{J} becomes a target e of the local search (step ST26 in FIG. 6).

Specifically, for example, the determination method selecting unit 14a determines the probability pₑ^{j} in such a manner that the probability pₑ^{j} to be the target e of the local search is higher as the evaluation value y^{j} is lower for the elite solution E^{j}. In this manner, an effect of increasing the evaluation value of the entire elite solution is obtained. Further, the determination method selecting unit 14a may determine the probability pₑ^{j} in such a manner that the probability pₑ^{j} to be the target e of the local search is higher as the evaluation value y^{j} is higher for the elite solution E^{j}. In this manner, an effect of increasing the maximum value of the evaluation value of the elite solution is obtained.

Further, the determination method selecting unit 14a may determine the probability pₑ^{j} to be the target e of the local search in accordance with the distribution of the parameters that have already been tried. For example, the probability pₑ^{j} is determined in such a manner that the probability pₑ^{j} to be the target e of the local search increases as the distance from each elite solution E^{j} to the N_{close}-th nearest data increases. In this manner, an elite solution having sparse data distribution in the vicinity is more likely to be selected, and a search for an unsearched area is more likely to proceed.

The determination method selecting unit 14a selects an elite solution E^{j} to be the target e of the local search from among the J elite solutions E¹ to E^{J} on the basis of the probability pₑ^{j} that each of the J elite solutions E¹ to E^{J} becomes the target e of the local search (step ST27 in FIG. 6).

Specifically, the determination method selecting unit 14a selects the elite solution E^{j} to be the target e of the local search according to the probability pₑ^{j} from among the J elite solutions E¹ to E^{J} by using the pseudorandom number. A process of selecting one option from a plurality of options according to a predetermined probability using a pseudorandom number is a known technique, and thus a detailed description thereof will be omitted.

When the global search method is selected by the determination method selecting unit 14a, the sampling unit 14b samples the parameter value X-hat from a uniform distribution over the entire search space of parameter values, for example, using a pseudorandom number. The processing itself of sampling the parameter value X-hat using the pseudorandom number is a known technique, and thus detailed description thereof will be omitted. In the text of the specification, the symbol “A” cannot be attached to the letter “x” due to the electronic application, and thus it is written as “x-hat”.

In addition, the search space of parameter values is a space including a plurality of parameter values that can be used for the operation of the device 1 to be adjusted.

While the parameter value search space may be any search space, for example, if the search space of parameter values is a two-dimensional space, and the first dimension of the two-dimensional space is xᵢ and the second dimension of the two-dimensional space is x₂, rectangles having vertices at [x_{1L}, x_{2L}], [x_{1L}, x_{2H}], [x_{1H}, x_{2H}], and [x_{1H}, x_{2L}] are the search space. x_{1L} is a lower limit value of the parameter value x₁, x_{1H} is an upper limit value of the parameter value xᵢ, x_{2L} is a lower limit value of the parameter value x₂, and x_{2H} is an upper limit value of the parameter value x₂. In this case, a value that satisfies both x_{1L}≤xᵢ≤x_{1H} and x_{2L}≤x₂≤X_{2H} is a parameter value included in the search space.

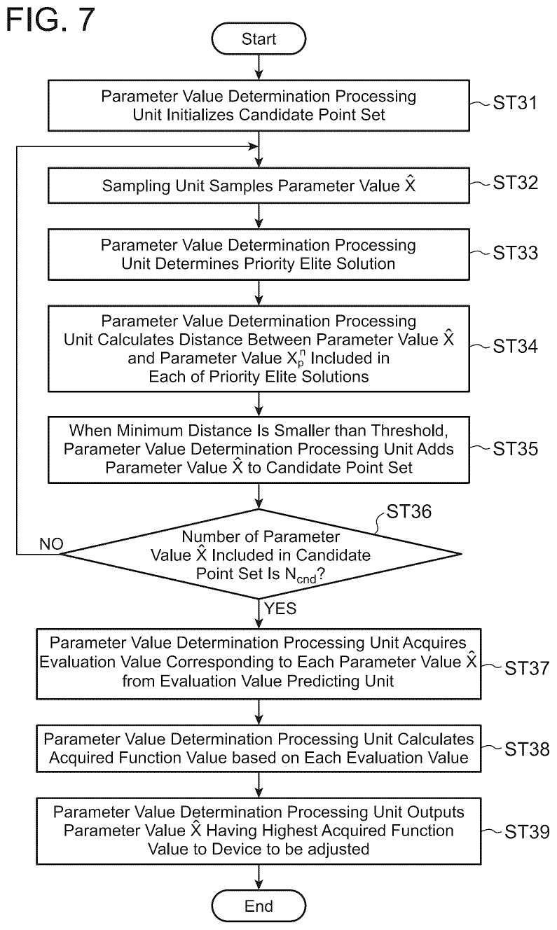

When the local search method is selected by the determination method selecting unit 14a, the sampling unit 14b samples one or more parameter values X-hat from a normal distribution centered on the elite solution E^{j}, which is the target e of the local search, in the search space of parameter values using, for example, a pseudorandom number. The timing at which the sampling unit 14b samples the parameter value X-hat is timing illustrated in step ST2 of FIG. 7 described later. The covariance matrix indicating the normal distribution may be determined in advance, or the sampling unit 14b may adjust the covariance matrix of the normal distribution in accordance with the search situation. In a case where the sampling unit 14b adjusts the covariance matrix, for example, each element of the covariance matrix is adjusted to be smaller as the evaluation value y^{j} of the elite solution E^{j} that is the target e of the local search is larger.

The sampling unit 14b outputs the sampled parameter value X-hat to the parameter value determination processing unit 14c.

FIG. 7 is a flowchart illustrating parameter value determination processing and the like by the parameter value determination processing unit 14c.

The parameter value determination processing unit 14c initializes a candidate point set C with an empty set (step ST31 in FIG. 7).

If the list E of the elite solutions is empty, that is, the number J of elite solutions is zero, the parameter value determination processing unit 14c adds the parameter value X-hat sampled by the sampling unit 14b to the candidate point set C.

If the number J of elite solutions is equal to or more than one, the parameter value determination processing unit 14c determines a priority elite solution (step ST33 in FIG. 7).

In other words, if the local search method is selected by the determination method selecting unit 14a, the parameter value determination processing unit 14c determines the elite solutions E¹ to E^{j-1} arranged earlier than the elite solution E^{j} that is the target e of the local search among the J elite solutions E¹ to E^{J} included in the list E as the priority elite solutions Ep¹ to Ep^{N}. N is the number of priority elite solutions, which in this case is equal to (j−1). The elite solution E^{j} that is the target e of the local search is the j-th elite solution E^{j} from the top of the list E.

The following Formula (6) illustrates a list Ep including the priority elite solutions Ep¹ to Ep^{N}.

$$Ep = [ {Ep}^{1} , … , {Ep}^{N} ] \qquad ( 6 )$$

In a case where the elite solution E^{j} that is the target e of the local search is the top of the list E, the number N of priority elite solutions is zero, and the list Ep is empty.

If the global search method is selected, the parameter value determination processing unit 14c determines J elite solutions E¹ to E^{J} included in the list E as priority elite solutions Ep¹ to Ep^{N}. At this time, N is equal to J.

When the number N of priority elite solutions is zero, the parameter value determination processing unit 14c adds the parameter value X-hat sampled by the sampling unit 14b to the candidate point set C.

In a case where the number N of priority elite solutions is equal to or more than one, the parameter value determination processing unit 14c calculates a distance s (X-hat, Xₚⁿ) between the extracted parameter value X-hat and the parameter value Xₚⁿ (n=1, . . . , N) included in each of the priority elite solutions Ep¹ to Ep^{N} included in the list Ep (step ST34 in FIG. 7). As the distance s (X-hat, Xₚⁿ), a distance of a parameter space can be used similarly to the distance d (X^{k}, X_{E}^{j}) described above.

In addition, the evaluation value or the value of the operation result may be predicted using machine learning, and the distance may be calculated using the prediction result.

The parameter value determination processing unit 14c compares the minimum value min s (X-hat, Xₚⁿ) of the distance between the extracted parameter value X-hat and the parameter value Xₚⁿ (n=1, . . . , N) included in each priority elite solution Eₚⁿ with the threshold δ. The threshold δ may be stored in the internal memory of the parameter value determination processing unit 14c or may be given from the outside of the parameter adjusting device 3.

As illustrated in the following Formula (7), when the minimum distance min s (X-hat, Xₚⁿ) is smaller than the threshold δ, the parameter value determination processing unit 14c adds the parameter value X-hat to the candidate point set C (step ST35 in FIG. 7).

$${min}_{{X}_{p}^{n} ∈ {E}_{p}} s ( \hat{X} , {X}_{p}^{n} ) < δ \qquad ( 7 )$$

When the number of parameter value X-hats included in the candidate point set C has not reached N_{cnd} (step ST36 in FIG. 7: NO), the parameter value determination processing unit 14c repeatedly executes the processing of steps ST32 to ST36. However, the processing in step ST32 is processing by the sampling unit 14b. N_{cnd} may be stored in the internal memory of the parameter value determination processing unit 14c or may be provided from the outside of the parameter adjusting device 3.

If the number of parameter value X-hats included in the candidate point set C has reached N_{cnd} (step ST36 in FIG. 7: YES), the parameter value determination processing unit 14c outputs each parameter value X-hat included in the candidate point set C to the evaluation value predicting unit 13.

The evaluation value predicting unit 13 acquires each parameter value X-hat included in the candidate point set C from the parameter value determination processing unit 14c.

The evaluation value predicting unit 13 gives each parameter value X-hat to the learning model 13a, and acquires at least an evaluation value y-hat corresponding to each parameter value X-hat from the learning model 13a.

When the parameter x-hat is given from the evaluation value predicting unit 13 at the time of inference, the learning model 13a outputs at least the evaluation value y-hat corresponding to the parameter value X-hat to the evaluation value predicting unit 13 as a prediction result of the evaluation value.

The evaluation value predicting unit 13 outputs an evaluation value y-hat corresponding to each parameter value X-hat to the parameter value determination processing unit 14c as a prediction result of the evaluation value.

In the parameter adjusting device 3 illustrated in FIG. 1, the evaluation value predicting unit 13 gives the parameter value X-hat to the learning model 13a and acquires the evaluation value y-hat corresponding to the parameter value X-hat from the learning model 13a. However, the evaluation value predicting unit 13 only needs to be able to predict the evaluation value y-hat corresponding to the parameter value X-hat, and may predict the evaluation value y-hat corresponding to the parameter value X-hat without using the learning model 13a.

The parameter value determination processing unit 14c acquires at least an evaluation value y-hat corresponding to each parameter value X-hat from the evaluation value predicting unit 13 (step ST37 in FIG. 7).

The parameter value determination processing unit 14c calculates an acquired function value based on at least each evaluation value y-hat (step ST38 in FIG. 7).

The parameter value determination processing unit 14c calculates the acquired function value using the acquired function. Examples of the acquisition function include upper confidence bound (UCB) and expected improvement (EI).

In a general acquisition function such as UCB or EI, it is assumed that a distribution of evaluation values, for example, an average and a variance are obtained when prediction is performed by machine learning, and the general acquisition function is often adopted when Gaussian process regression is used as a machine learning method. In the prediction, in a case where only a single deterministic value can be obtained, a function that returns the prediction evaluation value as it is may be used as the acquisition function.

The parameter value determination processing unit 14c selects the parameter value X-hat having the highest calculated acquired function value from among the one or more parameter values X-hat acquired from the sampling unit 14b.

The parameter value determination processing unit 14c outputs the parameter value X-hat having the highest acquired function value to the device 1 to be adjusted as the parameter value to be used by the device 1 to be adjusted for the next operation (step ST39 in FIG. 7).

In the parameter adjusting device 3 illustrated in FIG. 1, the parameter value determination processing unit 14c outputs the parameter value X-hat having the highest obtained function value to the device 1 to be adjusted as the parameter value to be used by the device 1 to be adjusted for the next operation. However, the parameter value used for the next operation by the device 1 to be adjusted is not limited to the parameter value X-hat having the highest acquired function value, and a parameter value X-hat having an acquired function value lower than the parameter value X-hat having the highest acquired function value may be output to the device 1 to be adjusted as the parameter value used for the next operation by the device 1 to be adjusted within a range in which there is no practical problem.

The device 1 to be adjusted performs operation using the parameter value X-hat output from the parameter value determination processing unit 14c, and outputs an operation result to the evaluation value calculating device 2.

Hereinafter, the parameter adjusting device 3 repeatedly performs the processing of steps ST1 to ST3 illustrated in FIG. 4.

In the first embodiment described above, the parameter adjusting device 3 is configured to include the data acquiring unit 11 to acquire data including a value of each of parameters and an evaluation value relating to the value of each of the parameters from the evaluation value calculating device 2 that acquires an operation result of the device 1 to be adjusted that performs operation using one parameter or a plurality of parameters and calculates an evaluation value for the operation result, and the elite solution extracting unit 12 to extract zero or more pieces of data as an elite solution from among a plurality of pieces of data acquired by the data acquiring unit 11 on the basis of an evaluation value included in each of the pieces of data. In addition, the parameter adjusting device 3 includes a parameter value determining unit to determine a value of a parameter to be used for the next operation by the device 1 to be adjusted on the basis of the elite solution extracted by the elite solution extracting unit 12 from among a plurality of values of parameters present in a search space for values of parameters, and output the determined value of the parameter to the device 1 to be adjusted. Therefore, even if the proper number of parameter values to be found is unknown, the parameter adjusting device 3 can search for diverse parameter values within the allowable range of degradation of the search efficiency.

In the parameter adjusting device 3 illustrated in FIG. 1, the evaluation value y calculated by the evaluation value calculating device 2 is a scalar value. However, this is merely an example, and the evaluation value calculating device 2 may calculate an evaluation vector Y having the number of dimensions L as expressed in the following Formula (8). L is an integer equal to or more than 2.

$$Y = [ {y}_{1} , {y}_{2} , … , {y}_{L} ] \qquad ( 8 )$$

In Formula (8), each of y₁, y₂, . . . y_{L} is an element included in the evaluation vector Y.

Then, the evaluation value calculating device 2 calculates a weighted sum of L elements y₁ to y_{L} included in the evaluation vector Y as the evaluation value y, for example, as illustrated in the following Formula (9).

As described above, the evaluation value calculating device 2 calculates the evaluation vector Y having the number of dimensions L, so that each element of the evaluation vector can be reflected in the distance d, and a plurality of parameter values having diversity can be searched for also in the evaluation vector space.

$$y = {w}_{1} {y}_{1} + … + {w}_{L} {y}_{L} \qquad ( 9 )$$

In Formula (9), each of w₁, . . . , and w_{M} is a weighting coefficient.

### Second Embodiment

In the second embodiment, a parameter adjusting device 3 will be described in which a parameter value determining unit 15 includes a determination method selecting unit 15a that selects a parameter determination method on the basis of an evaluation value included in an elite solution and an upper limit value of the evaluation value.

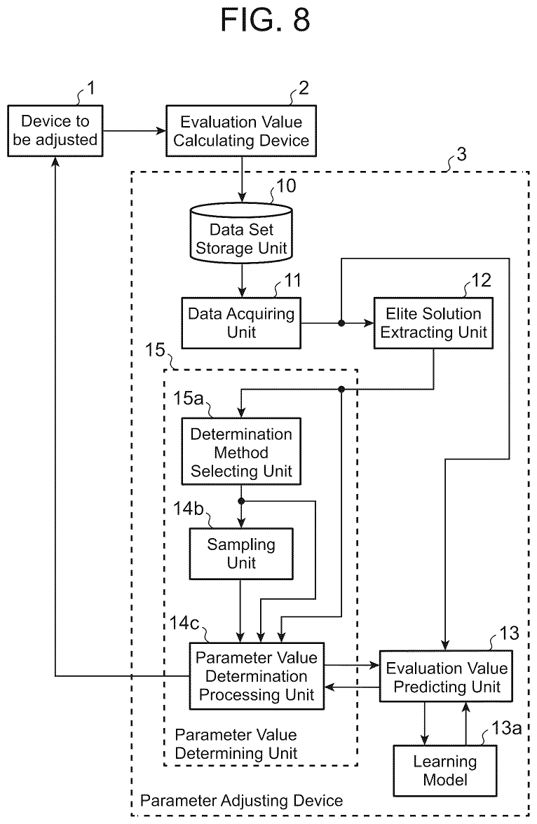

FIG. 8 is a configuration diagram illustrating a system including the parameter adjusting device 3 according to the second embodiment. In FIG. 8, the same reference numerals as those in FIG. 1 denote the same or corresponding parts, and thus description thereof is omitted.

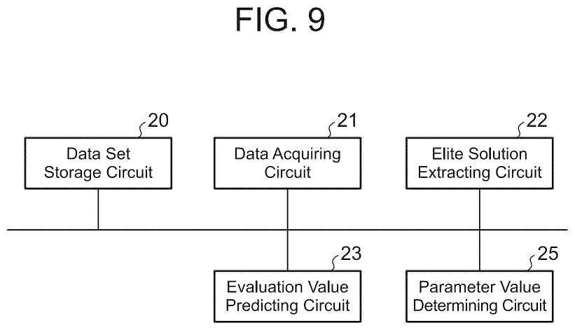

FIG. 9 is a hardware configuration diagram illustrating hardware of the parameter adjusting device 3 according to the second embodiment. In FIG. 9, the same reference numerals as those in FIG. 2 denote the same or corresponding parts, and thus description thereof is omitted.

The system illustrated in FIG. 8 includes a device 1 to be adjusted, an evaluation value calculating device 2, and the parameter adjusting device 3.

The parameter value determining unit 15 is implemented by, for example, a parameter value determining circuit 25 illustrated in FIG. 9.

The parameter value determining unit 15 includes a determination method selecting unit 15a, a sampling unit 14b, and a parameter value determination processing unit 14c.

The parameter value determining unit 15 determines a parameter value to be used for the next operation by the device 1 to be adjusted on the basis of an elite solution extracted by the elite solution extracting unit 12 from among a plurality of parameter values present in the search space of parameter values.

The parameter value determining unit 15 outputs the determined parameter value to the device 1 to be adjusted.

The determination method selecting unit 15a acquires J elite solutions E¹ to E^{J} from the elite solution extracting unit 12.

On the basis of the elite solutions E¹ to E^{J}, the determination method selecting unit 15a selects either the global search method or the local search method as the method of determining the parameter value to be used for the next operation.

Specifically, the determination method selecting unit 15a selects the global search method when the number J of elite solutions extracted by the elite solution extracting unit 12 is zero.

The determination method selecting unit 15a compares a lowest evaluation value yₘᵢₙ among the evaluation values y¹ to y^{J} included in the J elite solutions E¹ to E¹ with an upper limit value y_{H} of the evaluation value. When the evaluation value yₘᵢₙ is equal to or more than the upper limit value y_{H}, the determination method selecting unit 15a selects the global search method.

When the evaluation value yₘᵢₙ is lower than the upper limit value y_{H}, the determination method selecting unit 15a calculates the probability p that the local search method is selected.

The determination method selecting unit 15a selects either the global search method or the local search method on the basis of the probability p.

In FIG. 8, it is assumed that each of the data acquiring unit 11, the elite solution extracting unit 12, the evaluation value predicting unit 13, and the parameter value determining unit 15, which are components of the parameter adjusting device 3, is implemented by dedicated hardware as illustrated in FIG. 9. That is, it is assumed that the parameter adjusting device 3 is implemented by the data acquiring circuit 21, the elite solution extracting circuit 22, the evaluation value predicting circuit 23, and the parameter value determining circuit 25.

Each of the data acquiring circuit 21, the elite solution extracting circuit 22, the evaluation value predicting circuit 23, and the parameter value determining circuit 25 corresponds to, for example, a single circuit, a composite circuit, a programmed processor, a parallel programmed processor, an ASIC, an FPGA, or a combination thereof.

The components of the parameter adjusting device 3 are not limited to those implemented by dedicated hardware, and the parameter adjusting device 3 may be implemented by software, firmware, or a combination of software and firmware.

In a case where the parameter adjusting device 3 is implemented by software, firmware, or the like, a program for causing a computer to execute each processing procedure performed in the data acquiring unit 11, the elite solution extracting unit 12, the evaluation value predicting unit 13, and the parameter value determining unit 15 is stored in the memory 31 illustrated in FIG. 3. Then, the processor 32 illustrated in FIG. 3 executes the program stored in the memory 31.

Further, FIG. 9 illustrates an example in which each of the components of the parameter adjusting device 3 is implemented by dedicated hardware, and FIG. 3 illustrates an example in which the parameter adjusting device 3 is implemented by software, firmware, or the like. However, this is merely an example, and some components in the parameter adjusting device 3 may be implemented by dedicated hardware, and the remaining components may be implemented by software, firmware, or the like.

Next, operation of the system illustrated in FIG. 8 will be described. However, the system is similar to the system illustrated in FIG. 1 except for the determination method selecting unit 15a of the parameter value determining unit 15. Thus, only the operation of the determination method selecting unit 15a will be described here.

The determination method selecting unit 15a acquires J elite solutions E¹ to E^{J} from the elite solution extracting unit 12.

On the basis of the elite solutions E¹ to E^{J}, the determination method selecting unit 15a selects either the global search method or the local search method as the method of determining the parameter value to be used for the next operation.

Specifically, the determination method selecting unit 15a selects the global search method when the number J of elite solutions extracted by the elite solution extracting unit 12 is zero.

The determination method selecting unit 15a compares the lowest evaluation value yₘᵢₙ among the evaluation values y¹ to y^{J} included in the J elite solutions E¹ to E^{J} with the upper limit value y_{H} of the evaluation value.

When the evaluation value yₘᵢₙ is equal to or more than the upper limit value y_{H}, the determination method selecting unit 15a selects the global search method.

When the evaluation value yₘᵢₙ is lower than the upper limit value y_{H}, the determination method selecting unit 15a calculates the probability p that the local search method is selected.

The determination method selecting unit 15a selects either the global search method or the local search method on the basis of the probability p.

In a case where the global search method is selected, the determination method selecting unit 15a ends the determination method selection processing.

In a case where the local search method is selected, the determination method selecting unit 15a determines the probability pₑ^{j} that each of the J elite solutions E¹ to E^{J} becomes the target e of the local search.

In the second embodiment, the probability pₑ^{j} corresponding to the elite solution in which the evaluation value y^{j} included in the elite solution E^{j} is equal to or greater than the upper limit value y_{H} is assumed to be zero.

The determination method selecting unit 15a outputs the selection result of the parameter value determination method to the sampling unit 14b.

In the second embodiment described above, the parameter adjusting device 3 illustrated in FIG. 8 is configured in such a manner that the determination method selecting unit 15a selects the parameter determination method on the basis of an evaluation value included in an elite solution and an upper limit value of the evaluation value. Therefore, similarly to the parameter adjusting device 3 illustrated in FIG. 1, the parameter adjusting device 3 illustrated in FIG. 8 can search for diverse parameter values within the allowable range of degradation of the search efficiency even when the appropriate number of parameter values to be found is unknown. In addition, the parameter adjusting device 3 illustrated in FIG. 8 has a larger probability that the parameter value is sampled from the search space centered on the elite solution candidate having the evaluation value equal to or less than the upper limit value than the parameter adjusting device 3 illustrated in FIG. 1. As a result, the parameter adjusting device 3 illustrated in FIG. 8 can increase the probability that diverse parameter values are searched more than the parameter adjusting device 3 illustrated in FIG. 1.

### Third Embodiment

In a third embodiment, a parameter adjusting device 3 including a learning model 16a that extracts, when the local search method is selected by a determination method selecting unit 14a, data in the vicinity of elite solution E^{j} to be a target e of the local search among M pieces of data D¹ to D^{M} as training data and learns the evaluation value y corresponding to a parameter value X included in the training data will be described.

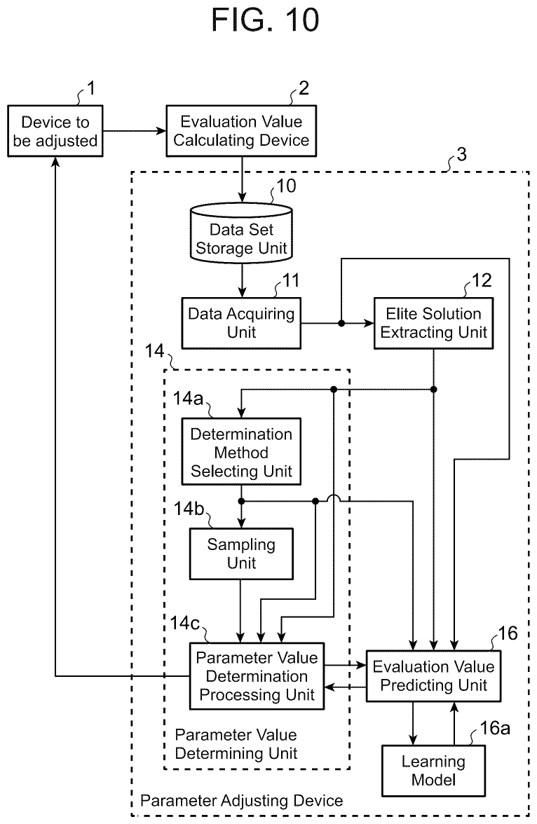

FIG. 10 is a configuration diagram illustrating a system including the parameter adjusting device 3 according to the third embodiment. In FIG. 10, the same reference numerals as those in FIGS. 1 and 8 denote the same or corresponding parts, and thus description thereof is omitted.

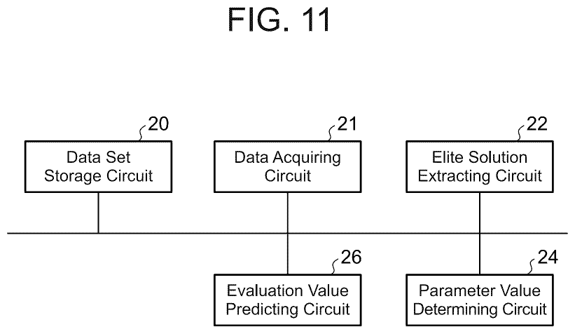

FIG. 11 is a hardware configuration diagram illustrating hardware of the parameter adjusting device 3 according to the third embodiment. In FIG. 11, the same reference numerals as those in FIGS. 2 and 9 denote the same or corresponding parts, and thus description thereof is omitted.

The system illustrated in FIG. 10 includes a device 1 to be adjusted, an evaluation value calculating device 2, and the parameter adjusting device 3.

An evaluation value predicting unit 16 is implemented by, for example, an evaluation value predicting circuit 26 illustrated in FIG. 11.

The evaluation value predicting unit 16 predicts an evaluation value for the operation result of the device 1 to be adjusted when the device 1 to be adjusted operates using each parameter value sampled by a sampling unit 14b of a parameter value determining unit 14.

When the global search method is selected by the determination method selecting unit 14a at the time of learning of the learning model 16a, the evaluation value predicting unit 16 gives each of the M pieces of data D¹ to D^{M} acquired by a data acquiring unit 11 to the learning model 16a.

When the local search method is selected by the determination method selecting unit 14a at the time of learning of the learning model 16a, the evaluation value predicting unit 16 extracts data in the vicinity of the elite solution E^{j} to be the target e of the local search among the M pieces of data D¹ to D^{M} as training data and gives the training data to the learning model 16a.

The learning model 16a is implemented by, for example, a Gaussian process regression model, a linear regression model, a neural network, a decision tree, a random forest, or a gradient boosting tree.

When the global search method is selected by the determination method selecting unit 14a at the time of learning, the learning model 16a acquires data D^{m}(m=1, . . . , M) acquired by the data acquiring unit 11 from the evaluation value predicting unit 16.

The learning model 16a learns the evaluation value y corresponding to the parameter value X included in the data D^{m} (m=1, . . . , M).

When the local search method is selected by the determination method selecting unit 14a at the time of learning, the learning model 16a acquires, as training data, data near the elite solution E^{j} to be the target e of the local search among the M pieces of data D¹ to D^{M}.

The learning model 16a learns the evaluation value y corresponding to the parameter value X included in the training data.

When a parameter value X-hat is given from the evaluation value predicting unit 16 at the time of inference, the learning model 16a outputs an evaluation value y-hat corresponding to the parameter value X-hat to the evaluation value predicting unit 16 as a prediction result of the evaluation value.

The parameter adjusting device 3 illustrated in FIG. 10 incorporates the learning model 16a. However, this is merely an example, and the learning model 16a may be provided outside the parameter adjusting device 3.

In the parameter adjusting device 3 illustrated in FIG. 10, each of the evaluation value predicting unit 16 and the learning model 16a is applied to the parameter adjusting device 3 illustrated in FIG. 1. However, this is merely an example, and each of the evaluation value predicting unit 16 and the learning model 16a may be applied to the parameter adjusting device 3 illustrated in FIG. 8.

In FIG. 10, it is assumed that each of the data acquiring unit 11, the elite solution extracting unit 12, the evaluation value predicting unit 16, and the parameter value determining unit 14, which are components of the parameter adjusting device 3, is implemented by dedicated hardware as illustrated in FIG. 11. That is, it is assumed that the parameter adjusting device 3 is implemented by the data acquiring circuit 21, the elite solution extracting circuit 22, the evaluation value predicting circuit 26, and the parameter value determining circuit 24.

Each of the data acquiring circuit 21, the elite solution extracting circuit 22, the evaluation value predicting circuit 26, and the parameter value determining circuit 24 corresponds to, for example, a single circuit, a composite circuit, a programmed processor, a parallel programmed processor, an ASIC, an FPGA, or a combination thereof.

The components of the parameter adjusting device 3 are not limited to those implemented by dedicated hardware, and the parameter adjusting device 3 may be implemented by software, firmware, or a combination of software and firmware.

In a case where the parameter adjusting device 3 is implemented by software, firmware, or the like, a program for causing a computer to execute each processing procedure performed in the data acquiring unit 11, the elite solution extracting unit 12, the evaluation value predicting unit 16, and the parameter value determining unit 14 is stored in the memory 31 illustrated in FIG. 3. Then, the processor 32 illustrated in FIG. 3 executes the program stored in the memory 31.

Further, FIG. 11 illustrates an example in which each of the components of the parameter adjusting device 3 is implemented by dedicated hardware, and FIG. 3 illustrates an example in which the parameter adjusting device 3 is implemented by software, firmware, or the like. However, this is merely an example, and some components in the parameter adjusting device 3 may be implemented by dedicated hardware, and the remaining components may be implemented by software, firmware, or the like.

Next, operation of the system illustrated in FIG. 10 will be described. However, the system is similar to the system illustrated in FIG. 1 except for the evaluation value predicting unit 16 and the learning model 16a. Thus, only the operations of the evaluation value predicting unit 16 and the learning model 16a will be described here.

The evaluation value predicting unit 16 acquires the selection result of the search method from the determination method selecting unit 14a.

When the selection result of the search method indicates the global search method, the evaluation value predicting unit 16 acquires M pieces of data D¹ to D^{M} from the data acquiring unit 11 and gives the M pieces of data D¹ to D^{M} to the learning model 16a.

When the M pieces of data D¹ to D^{M} are given from the evaluation value predicting unit 16 at the time of learning, the learning model 16a learns the evaluation value y corresponding to the parameter value X included in the data D^{m} (m=1, . . . , M).

If the selection result of the search method indicates the local search method, the evaluation value predicting unit 16 extracts, as training data, data near the elite solution E^{j} to be the target e of the local search among the M pieces of data D¹ to D^{M}, and gives the training data to the learning model 16a. As the nearby data, for example, data inside the 3σ confidence interval of the normal distribution used when the sampling unit 14b performs sampling may be used.

In addition, since some machine learning methods allows setting a weight for each data, learning may be performed by using all of the M pieces of data as training data and giving a weight that is heavier as the distance between each piece of data and the elite solution is shorter.

The learning model 16a learns the evaluation value y corresponding to the parameter value X included in the training data at the time of learning.

Upon receiving the parameter value X-hat from the parameter value determination processing unit 14c, the evaluation value predicting unit 16 gives the parameter value X-hat to the learning model 16a and acquires the evaluation value y-hat corresponding to the parameter value X-hat from the learning model 16a.

When the parameter value X-hat is given from the evaluation value predicting unit 16 at the time of inference, the learning model 16a outputs an evaluation value y-hat corresponding to the parameter value X-hat to the evaluation value predicting unit 16 as a prediction result of the evaluation value.

The evaluation value predicting unit 16 outputs an evaluation value y-hat corresponding to the parameter value X-hat to the parameter value determination processing unit 14c as a prediction result of the evaluation value.

In a case where the local search is selected by the determination method selecting unit 14a, the parameter value X-hat included in the candidate point set C is a parameter distributed only in the vicinity of the elite solution E^{j} to be the target e of the local search. Thus, there is no problem even if the prediction accuracy at a position far from the elite solution E^{j} to be the target e of the local search is low.

In the third embodiment described above, the parameter adjusting device 3 illustrated in FIG. 10 is configured to include the learning model 16a that learns the evaluation value y corresponding to the parameter value X included in data in the vicinity of the elite solution E^{j} to be the target e of the local search among the M pieces of data D¹ to D^{M} when the local search method is selected by the determination method selecting unit 14a. Therefore, the parameter adjusting device 3 illustrated in FIG. 10 can improve the prediction accuracy of the evaluation value in a case where the local search method is selected by the determination method selecting unit 14a as compared with the parameter adjusting device 3 illustrated in FIG. 1.

### Fourth Embodiment

The parameter adjusting device 3 according to the first to third embodiments can be applied to, for example, a simulation scenario generating device for an automated driving system.

When the parameter adjusting device 3 is applied to the simulation scenario generating device, it is possible to generate a scenario in which the automated driving system under development falls into an unsafe situation, and as a result, it is possible to improve the efficiency of safety verification of the automated driving system.

The scenario parameter used when the automated driving system executes the above scenario is the parameter value X used for the operation of the device 1 to be adjusted.

As the evaluation value for the operation result of the device 1 to be adjusted, for example, at least one of the degree of risk or the degree of discomfort is used.

The degree of risk is an index indicated by the automated driving system, representing how much the host vehicle has fallen into a dangerous situation. For example, in the case of the degree of risk of collision between the host vehicle and another vehicle, the degree of risk may be obtained by multiplying the inter-vehicle distance when the host vehicle approaches the other vehicle most by, for example, −1.

In addition, as the risk degree in a case where a traffic rule is broken, for example, the importance degree of the broken traffic rule or the degree of the broken traffic rule can be used.

The risk level may be expressed by a scalar value or may be expressed by a vector having a value for each item.

In the automated driving system, it is necessary to avoid driving that makes the occupant feel uncomfortable in addition to avoiding dangerous driving.

The degree of discomfort indicates a degree of discomfort felt by the occupant.

As a specific example of the discomfort level, for example, acceleration of the host vehicle or a maximum absolute value of jerk which is jerk of the host vehicle can be used.

In the fourth embodiment, as the distance d defining the closeness between the parameter values in the elite solution extracting unit 12, for example, a Euclidean distance in a space spanned by z expressed in the following Formula (10) can be used.

$$z = [ X ( Tc - T ) , Y ( Tc - T ) , X ( Tc - T + 1 ) , Y ( Tc - T + 1 ) , … , X ( Tc ) , Y ( Tc ) ] \qquad ( 10 )$$

In Equation (10), Tc is a time when the host vehicle comes closest to another vehicle, and T is a constant.

z is a two-dimensional relative position (X(t), Y(t)) of another vehicle as viewed from the host vehicle.

### Fifth Embodiment

The parameter adjusting device 3 according to the first to third embodiments can be used as, for example, a control parameter adjusting device for an air conditioner.

In general, there is an advantage that the execution time of the air conditioning simulator is significantly shorter than the execution time of an actual device.

On the other hand, the air conditioning simulator cannot reproduce a part of the behavior in the actual device, and thus, even if the parameter value has a high evaluation on the simulator, the evaluation may be lowered in the actual device and a failure may occur.

In a case where a plurality of diverse parameter values is obtained as compared with a case where the number of parameter values obtained by using the air conditioning simulator is one, there is a higher possibility that a parameter value that achieves high evaluation is obtained even in the actual device.

In a fifth embodiment, an air conditioning simulator and an actual device are used in combination to enable efficient parameter adjustment.

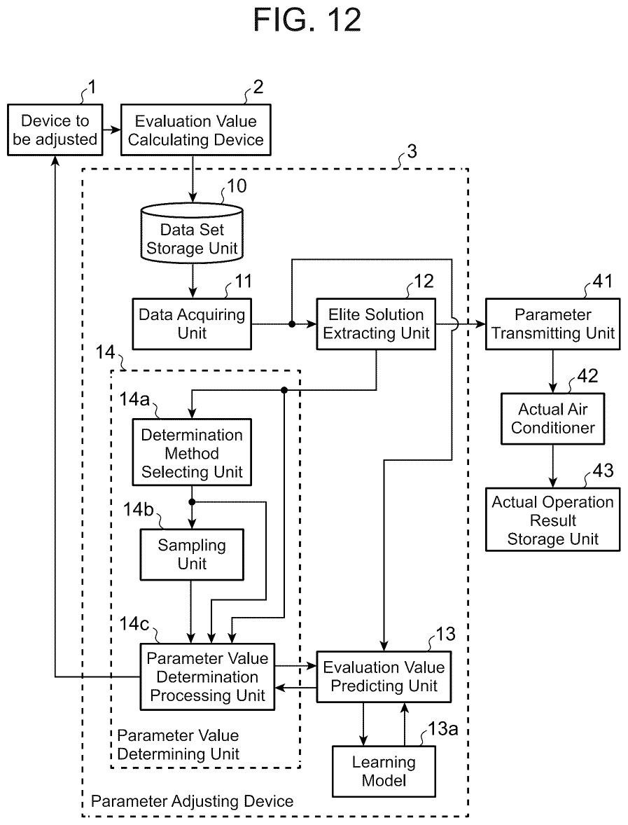

FIG. 12 is a configuration diagram illustrating a system including a parameter adjusting device 3 for an air conditioner according to the fifth embodiment.

In FIG. 12, the same reference numerals as those in FIGS. 1, 8, and 10 denote the same or corresponding parts, and thus description thereof is omitted.

The system illustrated in FIG. 12 includes a device 1 to be adjusted, an evaluation value calculating device 2, the parameter adjusting device 3, a parameter transmitting unit 41, an actual air conditioner 42, and an actual operation result storage unit 43.

In the system illustrated in FIG. 12, the device 1 to be adjusted is a simulator for an air conditioner. The device 1 to be adjusted has a function of calculating a state change of the air conditioner in accordance with an actuator operation pattern determined on the basis of a control parameter. An air conditioning state quantity is obtained as an operation result. Examples of the state quantity include a temperature of refrigerant, a pressure of refrigerant, heating capacity, cooling capacity, energy saving efficiency, and a temperature, a pressure, and enthalpy of each element constituting air conditioning.

The parameter adjusting device 3 illustrated in FIG. 12 is similar to the parameter adjusting device 3 illustrated in FIG. 1. However, this is merely an example, and the parameter adjusting device 3 illustrated in FIG. 12 may be similar to either the parameter adjusting device 3 illustrated in FIG. 8 or the parameter adjusting device 3 illustrated in FIG. 10.

In the fifth embodiment, the control parameter that determines the actuator operation pattern is the parameter value X used for the operation of the device 1 to be adjusted.

As an evaluation value for the operation result of the device 1 to be adjusted, for example, at least one of a temperature of refrigerant, a pressure of refrigerant, heating capacity, cooling capacity, energy saving efficiency, or a startup time is used. The startup time is a time until the internal state of the air conditioner reaches a steady state.

In the fifth embodiment, as the distance d defining the closeness between parameter values in the elite solution extracting unit 12, for example, a Euclidean distance in a space spanned by z expressed in the following Formula (11) can be used.

$$z = [ Pd ( 0 ) , Ps ( 0 ) , Pd ( Δ t ) , Ps ( Δ t ) , Pd ( 2 Δ t ) , Ps ( 2 Δ t ) , … , Pd ( N Δ t ) , Ps ( N Δ t ) ] \qquad ( 11 )$$

In Equation (11), Pd represents the pressure at the outlet of the compressor of the air conditioner, and Ps represents the pressure at the inlet of the compressor of the air conditioner.

Δt is a discrete time width, and N is the number of steps of the simulation.

z is a value in which the pressures Pd and Ps at the time t are arranged.

The parameter transmitting unit 41 acquires J elite solutions E¹ to E^{J} extracted by the elite solution extracting unit 12 of the parameter adjusting device 3.

The parameter transmitting unit 41 transmits the parameter value X included in the elite solution E^{j} (j=1, . . . , J) to the actual air conditioner 42.

The actual air conditioner 42 receives the parameter value X from the parameter transmitting unit 41.

The actual air conditioner 42 performs the air conditioning operation by setting the actuator operation pattern based on the parameter value X.

The actual operation result storage unit 43 acquires the operation state of the actual air conditioner 42 and stores the operation state in association with the parameter value X.

According to the fifth embodiment, it is possible to verify the operation state of the actual air conditioner 42 using control parameters having a high evaluation value and diversity. In addition, by performing parameter adjustment using the simulator, it is possible to increase the probability of obtaining a parameter value with a high evaluation value even when it is applied to the actual air conditioner 42 while greatly reducing the adjustment time.

Note that, in the present disclosure, free combinations of the embodiments, modifications of any components of the embodiments, or omissions of any components in the embodiments are possible.

### INDUSTRIAL APPLICABILITY

The present disclosure is suitable for a parameter adjusting device and a parameter adjusting method.

### REFERENCE SIGNS LIST

1: Device to be adjusted, 2: Simulator (Evaluation value calculating device), 3: Parameter adjusting device, 10: Data set storage unit, 11: Data acquiring unit, 12: Elite solution extracting unit, 13 and 16: Evaluation value predicting unit, 13a and 16a: Learning model, 14: Parameter value determining unit, 14a: Determination method selecting unit, 14b: Sampling unit, 14c: Parameter value determination processing unit, 15: Parameter value determining unit, 15a: Determination method selecting unit, 20: Data set storage circuit, 21: Data acquiring circuit, 22: Elite solution extracting circuit, 23 and 26: Evaluation value predicting circuit, 24 and 25: Parameter value determining circuit, 31: memory, 32: Processor, 41: Parameter transmitting unit, 42: Actual air conditioner, 43: Actual operation result storage unit

1. A parameter adjusting device comprising:
a data acquiring circuit to acquire data including a value of each of parameters and an evaluation value relating to the value of each of the parameters from an evaluation value calculating device that acquires an operation result of a device to be adjusted that performs operation using one parameter or a plurality of parameters and calculates an evaluation value for the operation result;
an elite solution extracting circuit to extract zero or more pieces of data as an elite solution from among a plurality of pieces of data acquired by the data acquiring circuit on a basis of an evaluation value included in each of the pieces of data; and
a parameter value determining circuit to determine a value of a parameter to be used for next operation by the device to be adjusted on a basis of the elite solution extracted by the elite solution extracting circuit from among a plurality of values of parameters present in a search space for values of parameters, and output the determined value of the parameter to the device to be adjusted,
wherein the parameter value determining circuit includes:
a determination method selecting circuit to select one of a global search method and a local search method as a method of determining a value of a parameter to be used for next operation on a basis of an elite solution extracted by the elite solution extracting circuit;
a sampling circuit to sample a value or values of one or more parameters in accordance with a probability distribution uniformly spreading over the entire search space when the global search method is selected by the determination method selecting circuit, and sample a value or values of one or more parameters in accordance with a probability distribution centered on a certain elite solution in the search space when the local search method is selected by the determination method selecting circuit; and
a parameter value determination processing circuit to calculate a distance between each of values of the parameters sampled by the sampling circuit and a value of a parameter included in the elite solution extracted by the elite solution extracting circuit, and on a basis of the distance, determine a value of a parameter to be used for next operation by the device to be adjusted from among values of one or more parameters sampled by the sampling circuit.

2. The parameter adjusting device according to claim 1, wherein
the determination method selecting circuit
selects either the global search method or the local search method on a basis of a probability that the local search method is selected when a number of elite solutions extracted by the elite solution extracting circuit is equal to or more than one.

3. The parameter adjusting device according to claim 1, wherein
the determination method selecting circuit
selects either the global search method or the local search method on a basis of a probability that the local search method is selected when a number of elite solutions whose evaluation values included are lower than an upper limit value among elite solutions extracted by the elite solution extracting circuit is equal to or more than one.

4. The parameter adjusting device according to claim 2, wherein
the determination method selecting circuit
calculates a probability that the local search method is selected on a basis of an evaluation value included in the elite solution extracted by the elite solution extracting circuit.

5. The parameter adjusting device according to claim 1, comprising:
an evaluation value predicting circuit to predict an evaluation value for an operation result of the device to be adjusted when the device to be adjusted performs operation using a value of each of parameters sampled by the sampling circuit, wherein
the parameter value determination processing circuit
determines a value of a parameter to be used for next operation by the device to be adjusted from among values of one or more parameters sampled by the sampling circuit on a basis of the distance and a prediction result of the evaluation value by the evaluation value predicting circuit.

6. The parameter adjusting device according to claim 5, wherein
when a value of a parameter included in each of pieces of data acquired by the data acquiring circuit and an evaluation value included in each of the pieces of data are given, the evaluation value predicting circuit gives the value of the parameter sampled by the sampling circuit to a learning model that learns an evaluation value corresponding to the value of each of parameters, and acquires, from the learning model, an evaluation value corresponding to the value of the parameter sampled by the sampling circuit as a prediction result of the evaluation value for the operation result of the device to be adjusted.

7. The parameter adjusting device according to claim 5, wherein
the evaluation value predicting circuit
gives, when the global search method is selected by the determination method selecting circuit, the value of the parameter sampled by the sampling circuit to a learning model that learns an evaluation value corresponding to a value of each of parameters when a value of a parameter included in each of pieces of data acquired by the data acquiring circuit and an evaluation value included in each of the pieces of data are given, and acquires, from the learning model, an evaluation value corresponding to the value of the parameter sampled by the sampling circuit as a prediction result of the evaluation value for the operation result of the device to be adjusted, and
extracts, when the local search method is selected by the determination method selecting circuit, some pieces of data among the data acquired by the data acquiring circuit as training data, and gives, when a value of a parameter included in each of pieces of the training data and an evaluation value included in each of the pieces of the training data are given, the value of the parameter sampled by the sampling circuit to the learning model that learns the evaluation value corresponding to the value of each of the parameters, and acquires, from the learning model, an evaluation value corresponding to the value of the parameter sampled by the sampling circuit as a prediction result of the evaluation value for the operation result of the device to be adjusted.

8. A parameter adjusting device comprising:
a data acquiring circuit to acquire data including a value of each of parameters and an evaluation value relating to the value of each of the parameters from an evaluation value calculating device that acquires an operation result of a device to be adjusted that performs operation using one parameter or a plurality of parameters and, that calculates an evaluation value for the operation result;
an elite solution extracting circuit to extract zero or more pieces of data as an elite solution from among a plurality of pieces of data acquired by the data acquiring circuit on a basis of an evaluation value included in each of the pieces of data; and
a parameter value determining circuit to determine a value of a parameter to be used for next operation by the device to be adjusted on a basis of the elite solution extracted by the elite solution extracting circuit from among a plurality of values of parameters present in a search space for values of parameters, and output the determined value of the parameter to the device to be adjusted, wherein
the elite solution extracting circuit
extracts, as an elite solution, data including evaluation values equal to or more than a lower limit value among a plurality of pieces of data acquired by the data acquiring circuit.

9. A parameter adjusting method comprising:
acquiring data including a value of each of parameters and an evaluation value relating to the value of each of the parameters from an evaluation value calculating device that acquires an operation result of a device to be adjusted that performs operation using one parameter or a plurality of parameters and calculates an evaluation value for the operation result;
extracting zero or more pieces of data as an elite solution from among a plurality of pieces of acquired data on a basis of an evaluation value included in each of the pieces of data; and
determining a value of a parameter to be used for next operation by the device to be adjusted on a basis of the extracted elite solution from among a plurality of values of parameters present in a search space for values of parameters, and outputting the determined value of the parameter to the device to be adjusted,
wherein the parameter adjusting method comprises:
selecting one of a global search method and a local search method as a method of determining a value of a parameter to be used for next operation on a basis of an extracted elite solution;
sampling a value or values of one or more parameters in accordance with a probability distribution uniformly spreading over the entire search space when the global search method is selected, and sampling a value or values of one or more parameters in accordance with a probability distribution centered on a certain elite solution in the search space when the local search method is selected; and
calculating a distance between each of values of the sampled parameters and a value of a parameter included in the extracted elite solution, and on a basis of the distance, determine a value of a parameter to be used for next operation by the device to be adjusted from among values of one or more sampled parameters.
